(19) United States
(12) Patent Application Publication
(10) Pub. No.: US 2003/0223487 A1
(43) Pub. Date: Dec. 4, 2003

(54) Measurement of jitter in digital communications signals

(75) Inventor: John Fisher, South Queensferry (GB)

Correspondence Address: Allan M. Lowe, c/o Lowe, Hauptman, Gilman & Berner, Suite 310, 1700 Diagonal Road, Alexandria, VA, 22314, US

(73) Assignee: Agilent Technologies, Inc.

(21) Appl. No.: 10/447,139

(22) Filed: May 29, 2003

(30) Foreign Application Priority Data
May 29, 2002 (EP) 02253762.5

(51) Int. Cl. H04Q 1/20; H04B 3/46

(52) U.S. Cl. 375/226

(57) ABSTRACT

Measurement of jitter in a digital communications signal is accomplished by generating multiple successive samples representative of jitter in a digital communications signal and supplying the successive samples in parallel to several (e.g. five) high-pass filter functions to generate filtered samples. The filtered samples from each high-pass filter function are passed to a respective measurement function, for measurement of parameters of the filtered samples from the corresponding high-pass filter function. The parameters include jitter peak amplitude and jitter RMS amplitude. Parameter measurements provided by the measurement functions are selected according to the measurement bandwidth(s) required for the jitter measurement, and a measurement of jitter in the communications signal is derived from those parameter measurements. Measurement of jitter in digital communications signals

### TECHNICAL FIELD

This invention relates to methods and apparatus for measuring jitter affecting digital signals used for transmitting information in communications networks.

### BACKGROUND ART

Digital communications networks are continuing to grow relentlessly in extent and capacity, and to become increasingly pervasive in the social and business infrastructure of many countries. Consequently test and measurement equipment for assisting monitoring and management of such networks to avoid interruption of their operation is crucially important.

One key test parameter of a digital communications network and of its component elements is timing jitter, which is defined in publications of the International Telecommunications Union (ITU) as “short-term variations of the significant instances of a digital signal from their ideal positions in time (where short-term implies these variations are of frequency greater than or equal to 10 Hz)”. Limits are specified in various international standards (e.g. ITU-T Recommendations G.823, G.824 and G.825) for maximum permissible levels of jitter at interfaces within a digital network. Typically limits are specified in pairs, one for a measurement using a wide-band measurement filter and one using a high-band measurement filter (with a lower cut-off frequency which is above that of the wide-band filter, and with the same minimum upper cut-off frequency). The wide-band filter's lower cut-off frequency is chosen in accordance with the characteristics of timing circuits (e.g. implemented as either phase-locked loops or high-pass filters) which may be incorporated in network equipment. The high-band filter's lower cut-off frequency is related to the bandwidth of input timing acquisition circuitry. The minimum upper cut-off frequency is chosen to reflect reasonable measurement limitations and to include all expected, significant alignment jitter. In practice the required measurement bandwidth is implemented by using a fixed low-pass, wide-band filter for one measurement and switching in a high-pass filter for the other measurement. An additional RMS jitter measurement is performed using a third high pass filter selection.

Network equipment can typically be configured to operate at any one of several different rates of transmission of data symbols (line rates), in a hierarchy of related rates such as those specified in the SONET (Synchronous Optical Network) and SDH (Synchronous Digital Hierarchy) systems. Each line rate has respective pairs of wide-band and high-band measurement bandwidths specified, usually requiring respective high-pass filters which are switched in to enable one or both of the two measurements to be made for a particular line rate. For each line rate there is also a different low pass filter. For certain purposes measurements at bandwidths additional to those required by the standards may be desirable.

A jitter measurement test usually takes several minutes. Therefore completing measurements for all filter combinations desired for a given line rate can be very time consuming.

### DISCLOSURE OF INVENTION

According to one aspect of this invention there is provided a method of measuring jitter in a digital communications signal, comprising the steps of:

generating multiple successive samples representative of jitter in a digital communications signal;

supplying the successive samples in parallel to a plurality of high-pass filter functions to generate filtered samples;

supplying the filtered samples from each high-pass filter function to a respective one of a plurality of measurement functions, for measurement of parameters of the filtered samples from the corresponding high-pass filter function, the parameters comprising jitter peak amplitude and jitter RMS amplitude; and

selecting parameter measurements provided by the measurement functions and deriving therefrom a measurement of jitter in the communications signal.

According to another aspect of this invention there is provided apparatus for measuring jitter in a digital communications signal, comprising:

a generator for generating multiple successive samples representative of jitter in a digital communications signal;

a plurality of high-pass filters for receiving the successive samples in parallel to generate filtered samples;

for each high-pass filter, a respective plurality of measurement circuits for receiving and measuring parameters of the filtered samples from that high-pass filter, the parameters comprising jitter peak amplitude and jitter RMS amplitude; and

a selector for selecting parameter measurements provided by the measurement circuits and deriving therefrom a measurement of jitter in the communications signal.

### BRIEF DESCRIPTION OF DRAWINGS

A method and apparatus in accordance with this invention, for measuring jitter in a communications signal, will now be described, by way of example, with reference to the accompanying drawings, in which:

FIG. 1 is a block schematic diagram of principal components of jitter measurement circuitry;

FIG. 2 is a block schematic diagram of filter and measurement functionality implemented in a field programmable gate array (FPGA) forming part of the circuitry of FIG. 1; and

FIG. 3 is a block schematic diagram of a parallel feedback processing function incorporated in the FPGA of FIG. 2.

### BEST MODE FOR CARRYING OUT THE INVENTION, & INDUSTRIAL APPLICABILITY

The circuitry shown in the drawings implements five high-pass filter functions and a parallel, through-path which operate simultaneously so the jitter data in six different measurement bandwidths is available simultaneously. In this particular example the parallel processing capabilities of an FPGA are used to provide digital high-pass filter banks, and also provide low-pass filtering for some line rates. This is advantageous in comparison to analogue filters which typically exhibit some variation in filter characteristic from unit to unit, requiring careful design and setup adjustments to compensate. In addition a large area of circuitry would be required to implement several different bandwidth options using analogue components, leading to a physically bulky and awkward equipment. Furthermore an analogue implementation to provide simultaneous measurement results would require multiple, costly analogue-to-digital converters (ADCs) in parallel and associated peripheral components.

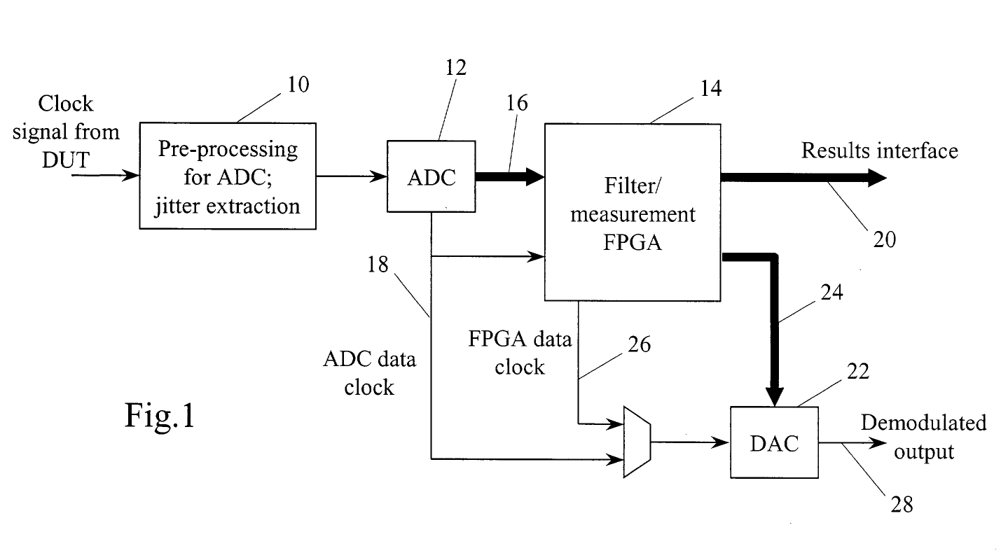

Referring to FIG. 1, a clock signal from a device under test (DUT), such as a communications network element, is supplied to a pre-processing circuit 10 which prepares the signal for input to an ADC 12. This pre-processing includes for example phase detection to extract the jitter component of the clock signal, and filtering for anti-aliasing. The ADC 12 samples the input signal at a suitable sample rate, dependent on the jitter measurement bandwidth, and provides 12-bit digitised values of the successive samples to a filter/measurement FPGA 14 via a parallel data bus 16, together with a data clock signal on a line 18. The FPGA 14 filters and measures the samples as described in more detail below, so that the required jitter measurements can be derived and output on a parallel results bus interface 20 for display, further processing etc. Selected samples as filtered by the FPGA 14 are also output to a digital-to-analogue converter (DAC) 22 via a parallel bus 24, together with a clock signal on a line 26, so that a demodulated signal representative of the jitter in the signal from the DUT can be output on a line 28.

As noted above, during a measurement the FPGA implements five parallel high-pass filter functions. The output of each filter and of a through-path is processed by a peak-to-peak measurement module, a root-mean-square (RMS) measurement module and a jitter peak occurrence (hit) counter module within the FPGA. There are one peak-to-peak module, one RMS module and one jitter peak occurrence counter module for each filter/path, all processing data simultaneously. This arrangement provides a significant time saving by making all required measurements for a given line rate with one instrument set-up. It also offers the advantage of providing RMS measurements for all bandwidth selections, for no extra set-up overhead.

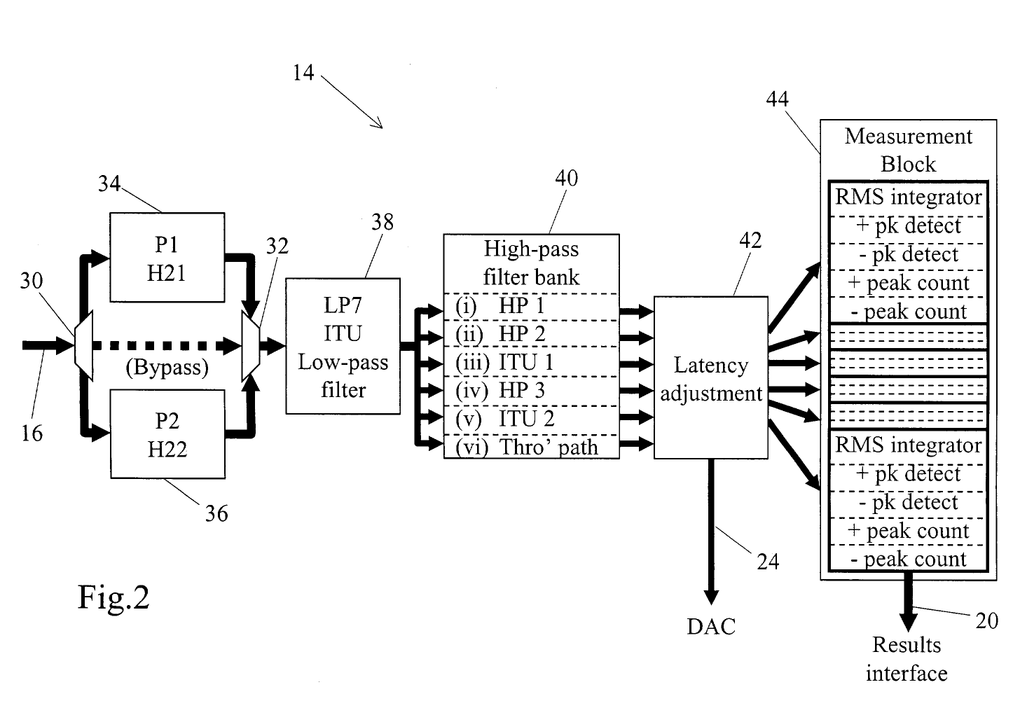

Referring to FIG. 2, the sample values output by the ADC on the data bus 16 are fed to a first of a pair of selectors 30 and 32 for selecting either of two post-emphasis filters 34 and 36 with filter characteristics H21 and H22 respectively, which compensate for clock recovery frequency response effects. The selectors 30 and 32 can also feed the received data samples directly from one to the other, to bypass the post-emphasis filtering.

The data samples emerging from the selector 32 are passed through a filter 38, implementing the low-pass filtering function required by the ITU Recommendations, to a bank 40 of digital high-pass filter functions. This bank comprises five filter functions 40(i) to 40(v) together with a through path 40(vi). The filter functions 40(iii) and 40(v) implement the high-band measurement bandwidths required by the ITU Recommendations for the line rate being tested. The functions 40(i), 40(ii) and 40(iv) provide a third bandwidth for RMS jitter measurements and two further bandwidths which are considered to be useful to provide additional versatility in a jitter test environment. As indicated by the parallel arrows entering the bank 40, the data samples from the filter 38 are supplied to all the filter functions 40(i) to 40(vi) simultaneously.

The outputs from the high-pass filter functions and the through path are connected to a latency adjustment circuit 42, to ensure that the filter delay for a given sample is the same for each path and the parallel measurements are therefore simultaneous, and from there to a measurement block 44. The measurement block 44 implements six sets of measurement functions, each set comprising an RMS integrator, positive peak detector, negative peak detector, positive peak occurrence counter and negative peak occurrence counter. Each of these six sets of measurement functions is coupled to a respective high-pass filter function or the through path in the bank 40 via a respective path through the latency adjustment circuit 42, so that data processing for the measurement functions implemented in the block 44 proceeds for all six filter functions in the bank 40 simultaneously. The measurement block 40 accumulates measurement information over a succession of measurement intervals, and the results of the data processing at the end of each measurement interval are supplied by the measurement block 44 via the results interface 20 to an instrument processor for reporting of the required jitter measurements in conventional manner.

All the results collected during one measurement interval are available for display while the measurement results for the following interval are being accumulated. At the option of the user the jitter measurements for one, several or all of the high-pass filter functions 40 may be displayed simultaneously. Changes in display choices can be performed without any delay for gathering of the related measurements.

Data are supplied to the DAC 22 (FIG. 1) via the bus 24 from the circuit 42, which connects one of the outputs from the high-pass filter bank 40 to the bus 24 in accordance with a user selection.

In order to fit all the required data processing functionality into a commercially-available FPGA, separate FPGA configurations are used for each line rate, i.e. the FPGA is re-programmed from associated memory (not shown) each time a different line rate is selected by the user. Thus the FPGA only needs enough programmable array capacity to accommodate the measurement functionality for one line rate. In practice the functionality for more than one of the lower line rates may be lumped together in one FPGA configuration.

The digital filter implementations used for the high-pass filter functions 40 incorporate relatively wide (32-bit) data words to provide filter roll-off accuracy and measurement resolution. The filters are implemented as recursive infinite impulse response (IIR) filters to minimize the requirement for FPGA capacity. Three particular practical issues are addressed by this implementation of the filters:

The data rate required to sample the full jitter measurement bandwidth accurately (e.g. 204 MSPs) is very fast, such that, in conjunction with the 32-bit wide data words, the fastest available FPGA could not perform the feedback operation required (32×32 bit, fixed coefficient multiplication) for an IIR filter within one sample period.

Some of the high-pass filters have very low cut-off frequencies in relation to the data sampling rate, such that they could almost be considered as DC stops. However, the relevant jitter measurement standards require that the filters provide a 1^{st} order Butterworth roll-off characteristic, and that the cut-off frequency meets a specified tolerance, so a simple DC stop filter could not be used. The coefficient values comprising the definition of the digital filter functions therefore have to be very accurate.

In selecting multiplier coefficients for a digital filter, it is advantageous to be able to select a data sample rate that is related to the coefficients so as to reduce the coefficient multiplication operations to single and dual bit operations. More complex multiplication operations would require extra FPGA capacity, and would reduce the maximum speed at which the FPGA can perform the coefficient multiplication operations. In implementing a bank of filters operating simultaneously a data rate is selected to suit all the filters.

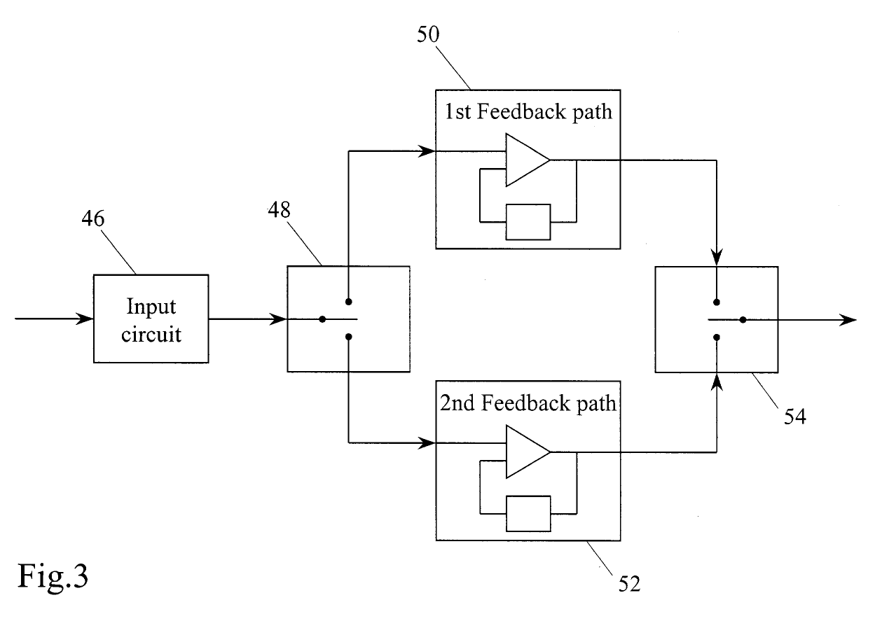

To address speed limitation of the FPGA device, a parallel pipeline process was used to “unwrap” the IIR feedback stage and allow it to be performed over two or more sample periods. This allowed the FPGA to perform the feedback function at half the data rate, effectively doubling the maximum data rate for the FPGA. The principles of the modified IIR feedback stage are illustrated in FIG. 3. Referring to FIG. 3, the input data for the feedback stage are supplied to an input circuit 46 which is coupled to a first commutator 48 which switches repetitively between two states at the sample data rate. In a first state the received data are fed through a first feedback path 50, implementing the required IIR feedback operation. In the commutator's second state the data are fed to a second feedback path 52, implementing the same feedback function. The outputs of the two feedback paths 50 and 52 are coupled to a second commutator 54 operating synchronously with the first commutator 48.

Thus two samples are processed in parallel, allowing two clock cycles in which to perform the complete IIR feedback operation for each sample. The unmodified IIR feedback path performs the following operation:

X(n)=u(n)−kX(n−1)

where X(n) is the output of the feedback path for the nth sample;

u(n) is the input to the feedback path for the nth sample; and

k is a constant feedback factor.

Considered over two sample periods this becomes:

X(n)=u(n)−ku(n−1)+k²X(n−2)

This summation is split into two sections:

X(n)=Y(n)+k²X(n−2)

Y(n)=u(n)−ku(n−1)

The Y(n) summation is performed in the input stage 46 and can be done at full rate as it is a feed forward circuit and can be pipelined. The X(n) summation is accomplished over two sample periods, using the two multiplexed parallel feedback paths 50 and 52.

The term k² is implemented as a fixed coefficient. Some approximation occurs owing to quantization of the k² term. However, the feedback loop only operates every two samples, reducing the accumulation of such error. This reduction in error accumulation has a more dominant effect on the accuracy of the filter response than the approximation error.

To derive the filter coefficient values and the multiplier coefficients, a set of mathematical software modelling programs are used to design and analyse a bank of high pass filters over a range of possible data sample rates. The programs also analyse the filters at each data rate to identify the number of summation operations required to create a ‘sum of bit-shifted inputs’ implementation of the coefficient multiplier. Some sample frequencies could only be used if the coefficients are implemented using a large number of summations, so these frequencies are preferably avoided. The results of this modelling are inspected to identify a sample frequency that offers optimum accuracy, whilst allowing the simplest coefficients (least number of bits) to be used.

Once a candidate sample frequency has been chosen, the filter designs are simulated using a true fixed point simulator. The simulation results data are used as the FPGA test vectors.

The jitter measurement circuitry described above enables jitter measurement equipment to make multiple, simultaneous jitter measurements at different measurement bandwidths of a communications signal at a selected line rate, thereby effecting a substantial saving in time over previous sequential measurement approaches. The measurements can if desired be in real-time, and continuous (i.e. no interruption is needed to enable processing). This is advantageous in digital telecommunications test when failures that can occur as single events are to be detected. Equipment that has to conduct measurements discontinuously, with interruptions for processing, is liable miss such events (if they occur during an interruption) and is thus less useful to the end user.

1. A method of measuring jitter in a digital communications signal, comprising the steps of:
generating multiple successive samples representative of jitter in a digital communications signal;
supplying the successive samples in parallel to a plurality of high-pass filter functions to generate filtered samples;
supplying the filtered samples from each high-pass filter function to a respective one of a plurality of measurement functions, for measurement of parameters of the filtered samples from the corresponding high-pass filter function, the parameters comprising jitter peak amplitude and jitter RMS amplitude; and
selecting parameter measurements provided by the measurement functions and deriving therefrom a measurement of jitter in the communications signal.

2. The method of claim 1, wherein the measured parameters include a count of jitter peak occurrences over a predetermined time interval.

3. The method of claim 2, wherein the measured parameters include a count of jitter positive and negative peak occurrences over the predetermined time interval.

4. The method of claim 1, wherein the measured parameters include positive and negative jitter peak amplitudes.

5. The method of claim 1, wherein all measurements of jitter for a plurality of the high-pass filter functions are available for display simultaneously.

6. The method of claim 1, wherein one of the high-pass filter functions is a through path filter function.

7. Apparatus for measuring jitter in a digital communications signal, comprising:
a generator for generating multiple successive samples representative of jitter in a digital communications signal;
a plurality of high-pass filters for receiving the successive samples in parallel to generate filtered samples;
for each high-pass filter, a respective plurality of measurement circuits for receiving and measuring parameters of the filtered samples from that high-pass filter, the parameters comprising jitter peak amplitude and jitter RMS amplitude; and
a selector for selecting parameter measurements provided by the measurement circuits and deriving therefrom a measurement of jitter in the communications signal.
